(19) United States
(12) Patent Application Publication
(10) Pub. No.: US 2015/0046326 A1
(43) Pub. Date: Feb. 12, 2015

(54) DIGITAL CHECK SCANNER, SYSTEM AND METHOD FOR THE TRACEABILITY OF CHECKS

(71) Applicant: Panini S.p.A., Torino (TO) (IT)

(72) Inventor: Pierpaolo Bubbio, Torino (IT)

(73) Assignee: Panini S.p.A., Torino (TO) (IT)

(21) Appl. No.: 13/960,456

(22) Filed: Aug. 6, 2013

(51) Int. Cl. G06Q 20/04; G06Q 20/40

(52) U.S. Cl. CPC G06Q 20/042; G06Q 20/407
USPC 705/44; 705/45

(57) ABSTRACT

A digital check scanner (1), a system and a method for the traceability of checks are described, said digital check scanner (1) being associated to geographic detecting means (9) adapted to detect a geographical location of said digital check scanner (1).

The present invention relates to a digital check scanner, and to a system and a method for traceability of checks. More particularly, the present invention relates to a digital check scanner, a system and a method for traceability of checks in order to verify the reliability thereof and in order to observe national and international laws concerning currency.

Nowadays electronic money transactions are very widespread, suffice it to think of cash cards and also credit cards which are becoming more widespread than cash circulation.

Another very known payment method is that of checks. It is known that an American law known as “Check21”, signed by the former USA president George W. Bush and become effective in USA on October 2003, has made it legal to transmit a check by digital means and to print a substitution check at destination, called as “substitution check”, and in all respects equivalent to the original check. Since the physical printing of the paper substitution check is not strictly necessary, the law “Check21” has actually promoted the legality of the image of a check, captured by a digital scanner that is mainly specialized in this operation (called also as “check scanner”) and that implements also the ability to read and decode the magnetic MICR “codeline” (“Magnetic Ink Character Recognition”) written at the bottom of the check.

The possibility of legally transferring a check by means of its mere digital image clearly had a great influence in simplifying and accelerating bank transactions. Further, a phenomenon called as RDC (“Remote Deposit Capture”) has increasingly developed supported and promoted by the banks themselves which provides the possibility, for all the USA companies that receive checks in payment, to deposit them in a digital manner on their own bank account without physically going to the bank; this advantage, together with a very wide territory and a number of small and medium enterprises composed of few persons, promises a real revolution and a “new lease of life” for the check, which is converted at the source into a digital stream of data, likewise credit or debit cards.

Actually the RDC and the possibility of a remote and digital deposit of the check by companies, have arisen also an interesting opportunity. USA, as a consequence of the “Patriot Act” signed little after the attack of 11 September and other following actions, has drafted and is keeping a “black list” of countries from where it is forbidden to send money towards USA banks; on the other hand however, the RDC is actually a money deposit made by a company client of the bank, that in theory could operate in an anomalous manner or could cover deposits from undesired countries putting the bank itself in illegal conditions. Therefore it is essential to trace a check sent in an electronic manner in order to avoid the problems mentioned above.

It is therefore one object of the present invention to provide a digital check scanner, a system and a method for traceability of checks, allowing the legality of a check and of its drawer to be verified upon the deposit.

It is a second object of the present invention to provide a digital check scanner, a system and a method for traceability of checks, allowing national and international rules about currency to be observed.

These and other objects of the invention are achieved by a digital check scanner, a system and a method for traceability of checks as claimed in the annexed claims which are an integral part of the present description.

In short, the invention relates to a digital check scanner, a system and a method for traceability of checks, wherein the digital check scanner is associated to geographic detecting means adapted to detect a location of said scanner. This allows the place (geographical location) to be known from where the electronic trace of the check is sent and it allows possible not allowed money transactions to be blocked due to territory commitments imposed by national and international currency-related regulations in force. More in detail, the invention allows an operator in charge to take suitable measures, alarms or automatic blocks of the digital scanner or of the electronic money transaction, if the digital scanner operates outside an allowed geographical area and which is potentially related to forbidden or fraudulent activities.

Further features of the invention are set out in the appended claims, which are intended to be an integral part of the present description. The above objects will become more apparent from the following detailed description of a digital check scanner, a system and a method for traceability of checks with a particular reference to the annexed drawings wherein:

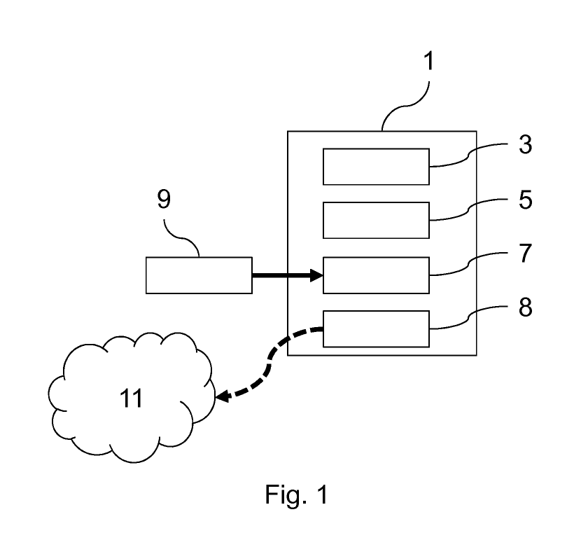

FIG. 1 is a block diagram of a digital check scanner according to a first embodiment of the present invention;

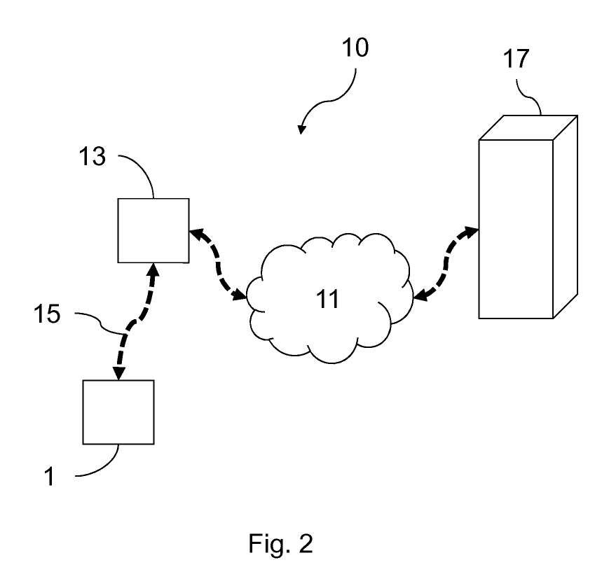

FIG. 2 is a system according to a second embodiment of the present invention.

With reference to FIG. 1, it shows a diagram of a digital check scanner 1 comprising scanning means 3 for an image of said check. It can also comprise reading means 5 of an optical and/or magnetic code, for example the MICR code of the check.

The digital scanner 1 further comprises interfacing means 7, particularly of the USB type (“Universal Serial Bus”) and/or Ethernet type for wired connections with external electronic devices, or of the Wi-Fi (“Wireless-Fidelity”), Wi-Fi Direct and Bluetooth type for wireless connections. It is clear that other types of interfaces can be implemented. Therefore, the digital scanner 1 is addressable through a IP address (“Internet Protocol”), preferably configurable by an external electronic device that can inspect the digital scanner 1 in all its functions by means of the HTTP communication protocol (“HyperText Transfer Protocol”) or HTTPS (cryptographic HTTP).

The digital scanner 1 further comprises transmitting means 8 adapted to transmit the data of a check in the digital electronic format. The transmitting means 8 allow the digital scanner 1 to be connected to a web network 11 and to this end they can use interfacing means 7, particularly an Ethernet or Wi-Fi interface. It has to be specified that the digital scanner 1 comprises also a processing and controlling unit (not shown in the figures) that manages all the elements provided therein.

The peculiarity of the digital check scanner 1 is the fact that it is associated to geographic detecting means 9 adapted to detect a geographical location of said digital check scanner 1.

Again with reference to FIG. 1, geographic detecting means 9 comprise at least one of the following satellite geographic tracking modules: one GPS module (“Global Positioning System”), a Galileo Module and a GLONASS module (“GLObal'naja NAavigacionnaja Sputnikovaja Sistema”).

In a first embodiment of the present invention, the geographic detecting means 9 preferably are a USB GPS flash drive (called also as Dongle GPS), which can be connected to a USB port of the interfacing means 7 of the digital check scanner 1.

In this case, the digital scanner 1 operates in an autonomous manner and by means of the geographic detecting means 9, particularly a USB GPS flash drive, it directly and periodically obtains information about its geographical location. Geographical location information preferably comprises latitude and longitude data.

Since it is adapted to obtain its own geographical location, the digital check scanner 1 can be configured for operating only in a specific geographical area, possibly set in the programming step before it is delivered to a customer. For example, the set geographical area can correspond to the one of the residence area of the customer. The digital check scanner 1 is further configured for stopping its operation if the geographical location detected by the geographic detecting means 9 (that is the geographical location of the digital scanner 12) is not within the geographical area set in the digital scanner 1. Thus, the digital check scanner 1 automatically blocks the money electronic transaction, if the operation of the digital scanner 1 occurs outside the allowed geographical area, thus avoiding potential activities forbidden by the law or fraudulent activities.

Further, the digital check scanner 1 is arranged for detecting the presence or absence of the geographic detecting means 9, particularly of the USB GPS flash drive, and for protecting itself against attempts of replacing, removing or tampering them. Should it be the case, the digital scanner 1 automatically stops itself.

It is clear that the geographic detecting means 9 can be included in the digital scanner 1, particularly can be integrated directly in its electronic board. For example, the digital scanner 1 can comprise at least one of the satellite geographic tracking modules mentioned above, that is a GPS module, a Galileo module and a GLONASS module.

With reference to FIG. 2, in a second embodiment of the present invention, it shows a system 10 comprising said digital check scanner 1, a processor 13 and a remote monitoring and controlling centre 17. The processor 13 is a desktop PC, a notebook, a tablet, a smartphone or anyway an electronic device external to the digital scanner 1 adapted to control and manage it. On such processor 13 a programming, or “web-based”, application is run, which controls the digital scanner 1 by API (“Application Programming Interface”), and it is adapted to send commands and receive data about a bank transaction (for example the image of the check, the MICR “codeline”, OCR information and so on).

In such system 10, the digital check scanner 1 operates in a mode called as slave mode, namely it is managed by the processor 13. The digital scanner 1 is connected to the processor 13 by a connection 15 made by means of the interfacing means 7, particularly a Ethernet or USB or Wi-Fi or Bluetooth interface. The communication can occur with a proprietary protocol (for example of Panini S.p.A) or with the HTTP or HTTPS protocol. The processor 13 is telematically connected to the remote monitoring and controlling centre 17 through the web network 11, particularly a VPN (“Virtual Private Network”) or a dedicated line.

Generally, the processor 13 resides in the same location as that of the digital scanner 1, therefore it is clear how in this case it is possible to match the geographical location of the processor 13 with that of the digital check scanner 1 connected thereto.

In such second embodiment the geographic detecting means 9 are included into the processor 13. It is clear that even in this case the digital check scanner 1 is associated to geographic detecting means 9 adapted to detect a geographical location of said digital check scanner 1, the digital scanner 1 and the processor 13 being directly connected with each other. In this case, the geographic detecting means 9 can be at least one GPS, Galileo and GLONASS module, or a mobile telephone communication module (GSM, GPRS, EDGE, UMTS, HSDPA, LTE, etc.) comprised into the processor 13. In fact, if the processor 13 were a tablet equipped with a mobile telephone communication module, it would be able to detect its own position through algorithms for the triangulation of telephone cells.

As an alternative, the geographic detecting means 9 are configured for detecting network information useful for tracking the geographical location of the digital scanner 1. Such network information comprise for example the language of the operating system installed on said processor 13, an IP address associated to said processor 13, data about a known Wi-Fi network and in the proximity of said processor 13, bouncing time of a Ethernet data packet sent from said processor 13 through the web network 11 to a known public site, a list of servers passed through by a Ethernet data packet sent from said processor 13 through said web network 11 to a known public site and analyzed by means of software tools adapted to determine their geographical location, for example “TRACERT” or the like.

For example, by the Wi-Fi network to which the processor 13 is connected and its network information (for example the IP), the processor 13 obtains the geographical location information thereof; such geographical location coinciding with that of the digital check scanner 1. Geographical location information, comprising the latitude and longitude data, is transmitted from the processor 13 through the web network 11 to the remote monitoring and controlling centre 17 (for example the software product Panini Avantor™) whose purpose is to detect the digital scanner 1 in real-time during all its movements, if any. In this case, the remote monitoring and controlling centre 17 contains in a memory thereof the forbidden geographical areas for each digital scanner 1 and therefore it manages an alarm logic allowing the possible block/alarm of the digital scanner 1 to be controlled if its geographical location is within the forbidden geographical areas.

As an alternative, the remote monitoring and controlling centre 17 in a memory thereof contains the allowed geographical areas for each digital check scanner 1 and it performs a comparison between geographical location information obtained from the processor 13 (and therefore of the digital scanner 1) and the known allowed geographical areas. If the geographical location is not included in the allowed geographical areas, it will send to the processor 13 a control command, particularly a block and/or alarm command, which would be repeated in turn on the digital scanner 1. Even in this case, the digital check scanner 1 automatically stops the electronic money transaction carried out on it, if any, thus avoiding potential activities forbidden by law or fraudulent activities.

The method according to the present invention provides the steps of:
detecting, by means of geographic detecting means 9, a geographical location of said digital check scanner 1, said geographic detecting means 9 being associated thereto;
blocking, by means of said digital check scanner 1, an electronic money transaction if said geographical location of the digital check scanner 1 falls outside a predetermined allowed geographical area.

Further, the method according to the invention provides to:
transmit, through the processor 13 and the web network 11, geographical location information to the remote monitoring and controlling and centre 17;
send a control command to the processor 13, through the remote monitoring and controlling centre 17, if the geographical location of the digital check scanner 1 falls outside a predetermined allowed geographical area.

It is clear that the control command can be a block, alarm, suspension command and so on. In practice, the electronic money transaction carried out from a not allowed geographical area is definitively or temporarily blocked.

It has to be point out that the steps of the method according to the invention are preferably carried out in connection with an initialization of an electronic money transaction by the digital check scanner 1 that performs it.

The method according to the invention can be implemented by means of a computer product which can be loaded into a memory of said digital check scanner 1 and/or of said processor 13 and/or of said remote monitoring and controlling centre 17 and comprising portions of software code adapted to implement the method itself.

Therefore from the description above it results clear the characteristics of the present invention, as well as its advantages are clear.

A first advantage of the digital check scanner, of the system and method for traceability of checks according to the present invention is to obtain the geographical location from where a bank transaction made by checks comes.

A second advantage of the digital check scanner, of the system and method according to the present invention is that it is possible to block bank transactions coming from non-authorized countries or nations or geographical areas.

A further advantage of the digital check scanner, of the system and method according to the present invention is to obtain the complete geographical traceability of bank transactions performed by means of a check.

There are many possible variants of the digital check scanner, of the system and method for traceability of checks described as an example, without for this reason departing from the novelty principles of the inventive idea, as well as it is clear that in its practical implementation the shapes of the shown details can be different, and they may be replaced by technically equivalent elements.

Therefore it is easy to understand that the present invention is not limited to a digital check scanner, a system and a method for traceability of checks, but it can be subjected to various changes, improvements, replacements of equivalent elements and parts without however departing from the idea of the invention, as better specified in the following claims.

1. Digital check scanner comprising:
a digital scanner; and
geographic detecting means associated with said digital scanner for detecting a geographical location of said digital scanner.

2. Digital check scanner according to claim 1, said digital scanner being configured for operating in a specific geographical area, and for stopping its operation if said geographical location detected by said geographic detecting means does not fall within said geographical area.

3. Digital check scanner according to claim 2, wherein said digital scanner is adapted to automatically block an electronic money transaction.

4. Digital check scanner according to claim 1, wherein said geographic detecting means are integrated into said digital scanner.

5. Digital check scanner according to claim 1, wherein said geographic detecting means comprise at least one of the following satellite geographic tracking modules: a GPS or “Global Positioning System” module, a Galileo module and a GLONASS or “GLObal'naja NAavigacionnaja Sputnikovaja Sistema” module.

6. Digital check scanner according to claim 1, wherein said geographic detecting means are a USB GPS flash drive connectable to a USB port of interfacing means of said digital check scanner.

7. Digital check scanner according to claim 6, wherein said interfacing means are of the USB and/or Ethernet type for wired connections, or of the Wi-Fi, Wi-Fi Direct and Bluetooth type for wireless connections.

8. Digital check scanner according to claim 1, wherein said digital scanner is arranged for detecting the presence or absence of said geographic detecting means associated thereto.

9. System for traceability of checks, said system comprising:
a digital check scanner,
a processor connected to said digital check scanner by a connection made by means for interfacing,
a remote monitoring and controlling centre telematically connected to said processor through a web network, said processor being adapted to control and manage said digital check scanner.

10. System for traceability of checks according to claim 9, wherein said connection provides a communication by HTTP or HTTPS or proprietary protocol.

11. System for traceability of checks according to claim 9, wherein said processor comprises geographic detecting means for detecting a geographical location of said digital check scanner.

12. System for traceability of checks according to claim 9, wherein said geographic detecting means comprise at least one GPS, Galileo and GLONASS module.

13. System for traceability of checks according to claim 9, wherein said geographic detecting means comprise a mobile telephone communication module.

14. System for traceability of checks according to claim 9, wherein said geographic detecting means are configured for detecting network information useful for tracking said geographical location of said digital check scanner.

15. System for traceability of checks according to claim 14, wherein said network information comprises:
a language of an operating system installed on said processor,
an IP address associated to said processor,
data about a known Wi-Fi network in proximity of said processor, bouncing time of a Ethernet data packet sent from said processor through said web network, to a known public site, a list of servers passed through by a Ethernet data packet sent from said processor through said web network to a known public site.

16. System for traceability of checks according to claim 9, wherein said processor transmits information of said geographical location, comprising latitude and longitude data, through said web network to said remote monitoring and controlling centre, which contains in a memory thereof the forbidden, or allowed, geographical areas, for each digital check scanner and it manages an alarm logic by sending a control command to said processor that in turn controls said digital check scanner.

17. System for traceability of checks according to claim 16, wherein said control command enables a block/alarm of said digital check scanner if said tracked geographical location falls within said forbidden geographical areas, outside said allowed geographical areas respectively.

18. System for traceability of checks according to claim 16, wherein said control command provides to automatically block a possible electronic money transaction performed on said digital check scanner.

19. Method for traceability of checks, said method comprising the steps of:
detecting a geographical location of a digital check scanner by use of means for geographically detecting; and
blocking, by means of said digital check scanner, an electronic money transaction if said geographical location of said digital check scanner falls outside a predetermined allowed geographical area.

20. Method according to claim 19, said method further comprising the steps of:
transmitting, through a processor and a web network, information about said geographical location to a remote monitoring and controlling centre;
sending a control command to said processor, through said remote monitoring and controlling centre, if said geographical location of said digital check scanner falls outside a predetermined allowed geographical area.

21. A computer product which can be loaded into a memory of said digital check scanner and/or of said processor and/or of said remote monitoring and controlling centre and comprising portions of software code adapted to implement the method itself.

22. Digital check scanner according to claim 2, wherein said digital scanner is configured to stop its operation if particularly latitude and longitude data detected by said geographic detecting means does not fall within said geographical area.

23. Digital check scanner according to claim 9, wherein said remote monitoring and controlling centre is telematically connected to said processor through a VPN, or “Virtual Private Network”, or a dedicated line.
